(19) United States
(12) Patent Application Publication
(10) Pub. No.: US 2024/0396494 A1
(43) Pub. Date: Nov. 28, 2024

(54) Crossing gaps between panels table for Robotic cleaning solution on PV panels.

(71) Applicant: Airtouch Solar Ltd., Beit Shemesh (IL)

(72) Inventors: Yanir Allouche, Tel Aviv (IL); Shay Blumental, Beit Shemesh (IL)

(73) Assignee: Airtouch Solar Ltd., Beit Shemesh (IL)

(21) Appl. No.: 18/701,604

(22) PCT Filed: Oct. 17, 2022
(86) PCT No.: PCT/IB2022/059951

§ 371 Date: Apr. 15, 2024

Related U.S. Application Data
(60) Provisional application No. 63/262,618, filed on Oct. 15, 2021.

(51) Int. Cl. H02S 40/10; B08B 1/34

(52) U.S. Cl. CPC H02S 40/10; B08B 1/34

(57) ABSTRACT

A surface cleaning device for cleaning surfaces of solar panels, wherein the surface cleaning device may include a main body, at least one extension that extends to at least one side of the main body and comprise at least one extension wheel for interfacing with the solar panels, a first dust carrying member, a second dust carrying member, a motor; and one or more motion delay assemblies; wherein the first dust carrying member and the second dust carrying member are coupled to the motor; wherein the motor is configured to cyclically move the first dust carrying member and the second dust carrying member along a path; wherein the one or more motion delay assemblies are is configured to cyclically introduce a momentarily delay in a progress of the first dust carrying member along the path.

### CROSS REFERENCE

This application claims priority from U.S. provisional patent Ser. No. 63/262,618 filing date Oct. 15, 2022 which is incorporated herein by reference in its entirety.

### BACKGROUND

Photovoltaic (PV) panels are mounted on racks/tables where each table carry 10-60 panels in big rectangle shape. Robotic cleaning solution need to have clear path to run on, steps or gaps above certain limit stop the robot from running smoothly.

New generation of robotic solutions are driving on the panels' frame and do not need a special rail to run on along the Rack/Table since the gaps between the panels is limited to 10-30 mm the wheels of normal robots can run over those gaps easily.

The challenge is to allow the robot to run between 2 adjacent tables that located next to each other on the same path. In this case a bridge between 2 adjacent tables is needed to allow one robot to continue running over the next table and cleaning of multiple tables. Save CAPEX.

On top of it, due to the nature of the market that looks to cut costs the frame of the table is plan to the minimum and also the panels themselves. This result a thinner and lighter rack's profiles and a thinner PV module frames. Robots load on such frame can cause the panels to suffer from cracks on the silicon layer due to load on the frame edges.

On top of that tables usually are aligned but, in many cases, due to lack of QC in the construction phase or due to difficult terrain, tables have misalignment between them.

In raw of 500 meter usually it will be required to install 75-100 bridges, each can cost 4-10$, that's requires substantial amount of investment to allow the robot to run smoothly along the raw. Some of the rows in big PV fields can hit 1000-1500 meters which the bridges burden can be even larger.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings;

FIG. 1 is an example of a surface cleaning device;

FIG. 2 is an example of a surface cleaning device;

FIG. 3 is an example of a surface cleaning device;

FIG. 4 is an example of a surface cleaning device;

FIG. 5 is an example of a surface cleaning device;

FIG. 6 is an example of a surface cleaning device;

FIG. 7 is an example of a surface cleaning device;

FIG. 8 is an example of a surface cleaning device;

FIG. 9 is an example of a surface cleaning device;

FIG. 10 is an example of a surface cleaning device; and

FIG. 11 is an example of a cleaning process.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

Any reference in the specification to a system should be applied mutatis mutandis to a method that may be executed by the system.

There is provided a surface cleaning device for cleaning surfaces of solar panels, wherein the surface cleaning device may include (i) a main body, (ii) at least one extension that extends to at least one side of the main body and comprise at least one extension wheel for interfacing with the solar panels; (iii) a first dust carrying member; (iv) a second dust carrying member; (v) a motor; and (vi) one or more motion delay assemblies. The first dust carrying member and the second dust carrying member are coupled to the motor.

The motor is configured to cyclically move the first dust carrying member and the second dust carrying member along a path.

The one or more motion delay assemblies are configured to cyclically introduce a momentarily delay in a progress of the first dust carrying member along the path, while the second dust carrying member contacts the surface thereby reducing a gap between the first dust carrying member and the second dust carrying member and induce air to exit the gap and progress along the surface and remove dust that precedes the second dust carrying member.

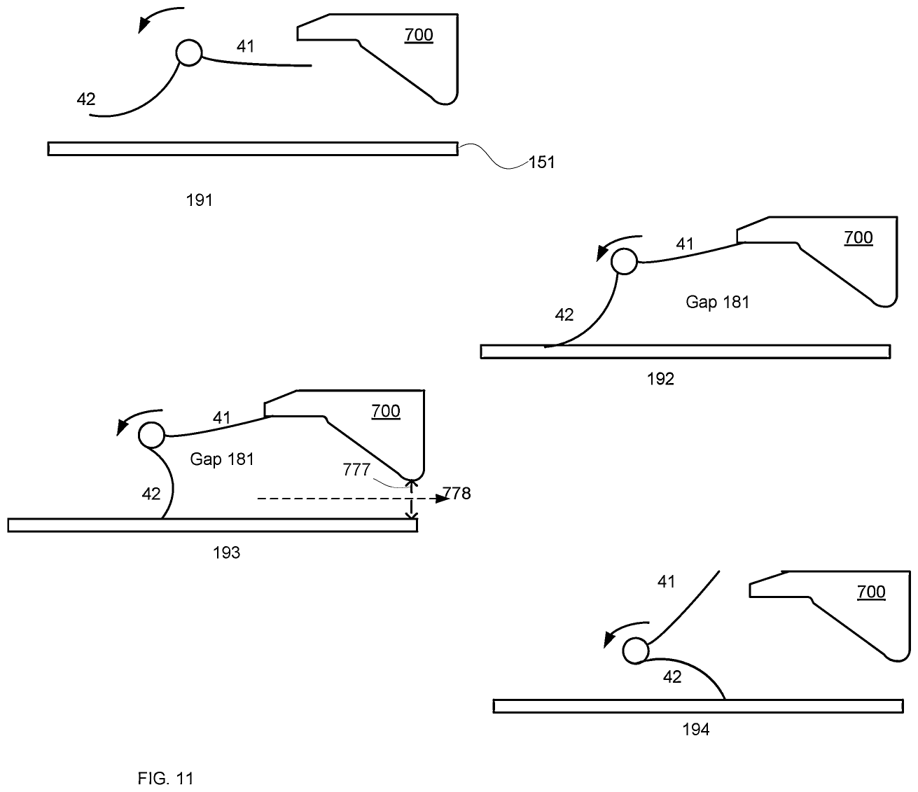

FIG. 11 illustrates scenarios 191, 192, 193, 193 and 194 of a first dust carrying member 41 and a second dust carrier member 42, the different scenarios occur at different consecutive points in time.

In scenario 191 the first dust carrying member 41 and the second dust carrier member 42 do not contact the surface 151 of the solar panel and do not contact motion delay assembly 700.

In scenario 192 the first dust carrying member 41 contacts motion delay assembly 700 while the second dust carrier member 42 first contacts the surface 151. There is a gap 181 between the first dust carrying member 41 and the second dust carrier member 42. The gap is also delimited by surface 151.

In scenario 193 the first dust carrying member 41 is still delayed by motion delay assembly 700 while the second dust carrier member 42 progresses along the surface 151—at a faster rate that the progress of the first dust carrier member 41—while decreasing the gap 181 and forcing air and dust to exit (see dashed arrow 778) the gap through an opening 777 formed between the surface 151 and a lower portion of motion delay assembly 700.

The at least one extension may be multiple extensions that extends to both sides of the main body and comprise extension wheels for interfacing with the solar panels.

The extension wheels may include surface wheels that are configured to interface with the surfaces of the solar panels and side wheels that are configured to interface with sidewalls of the solar panels.

The wheels associated with the main body may include surface wheels and side wheels.

The width of the surface cleaning device may exceed a width of a single solar panel.

The multiple extensions may be arranged in a symmetrical manner about the main body.

The center of gravity of the surface cleaning device may be located at the main body—thereby increasing the stability of the surface cleaning device—especially when passing gaps between adjacent solar panels.

The surface cleaning device may include one or more rotating elements for rotating at least one extension wheels and/or at least one main body wheels.

The rotating elements may include at least one rotating motor and one or more mechanical transmission elements for transmitting rotational motion from the one or more rotating motor to at least some of the wheels.

The one or more mechanical transmission elements may include chains and sprockets.

The one or more mechanical transmission elements may include chains, sprockets and an axel that couples extension wheel that are opposite to each other.

An increment in the number of the wheels to be rotated may increase the number of rotating motors and/or the number of mechanical transmission elements.

A distance between a pair of adjacent surface wheels may exceed a first predefined distance, wherein at least one of the pair is an extension wheel. The first predefined distance may exceed 20 centimeters.

A distance between a pair of adjacent side wheels may exceed a second predefined distance, wherein at least one of the pair is an extension wheel. The second predefined distance may exceeds 20 centimeters.

Any one of the first and second predefined distances may be set according to the gap between adjacent solar panels that should be passed by the surface cleaning device—without a dedicated bridge. The example of 20 centimeters is merely a non-limiting example—and the distance may be at least 25, 30, 35, 40 centimeter and the like.

The surface cleaning device may include a movement mechanism that is configured to move the surface cleaning device in relation to the solar panels. The movement mechanism may include one or more rotating elements for rotating at least some wheels of a group of wheels of the surface cleaning device. The at least some wheels may include an extension wheel and/or a wheel that is not an extension wheel.

There may be provided a method of cleaning a surface by a surface cleaning device, the method may include (i) cyclically moving, by a motor of the surface cleaning device, a first dust carrying member and a second dust carrying along a path; (ii) cyclically introducing, by one or more motion delay assemblies of the surface cleaning device, a momentarily delay in a progress of the first dust carrying member along the path, while the second dust carrying member contacts the surface thereby reducing a gap between the first dust carrying member and the second dust carrying member and inducing air to exit the gap and progress along the surface and remove dust that precedes the second dust carrying member; (iii) moving, by a movement mechanism, the surface cleaning device in relation to the solar panels, wherein the movement comprises moving at least one extension wheel of at least one extension of the surface cleaning device, the at least one extension extends to at least one side of a main body of the surface cleaning device.

The moving may include moving the surface cleaning device along a cleaning path for cleaning one solar panel, and moving over a gap between one solar panel to another solar panel without using a bridge. The gap may be a x-axis gap and/or a y-axis gap and/or a z-axis (height) gap. The cleaning path may be across a longitudinal axis of an array of solar panels.

During the moving of the surface cleaning device, one wheel of the surface cleaning device may contact one solar panel while another wheel of the surface cleaning device may contact another solar panel.

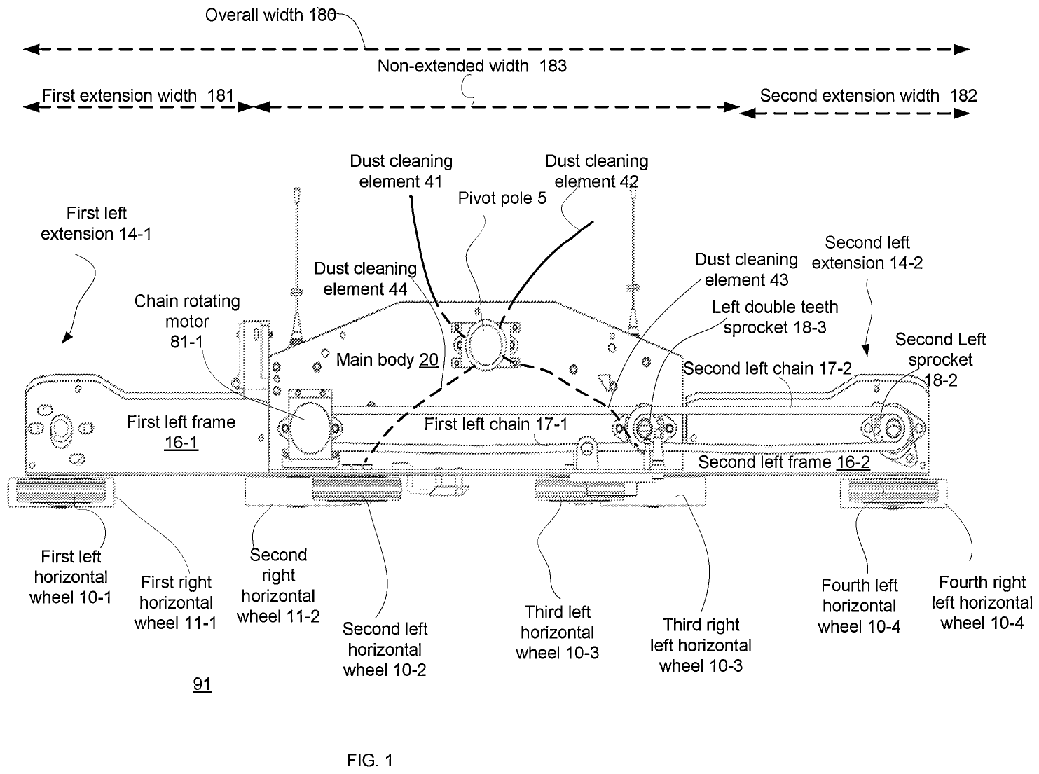

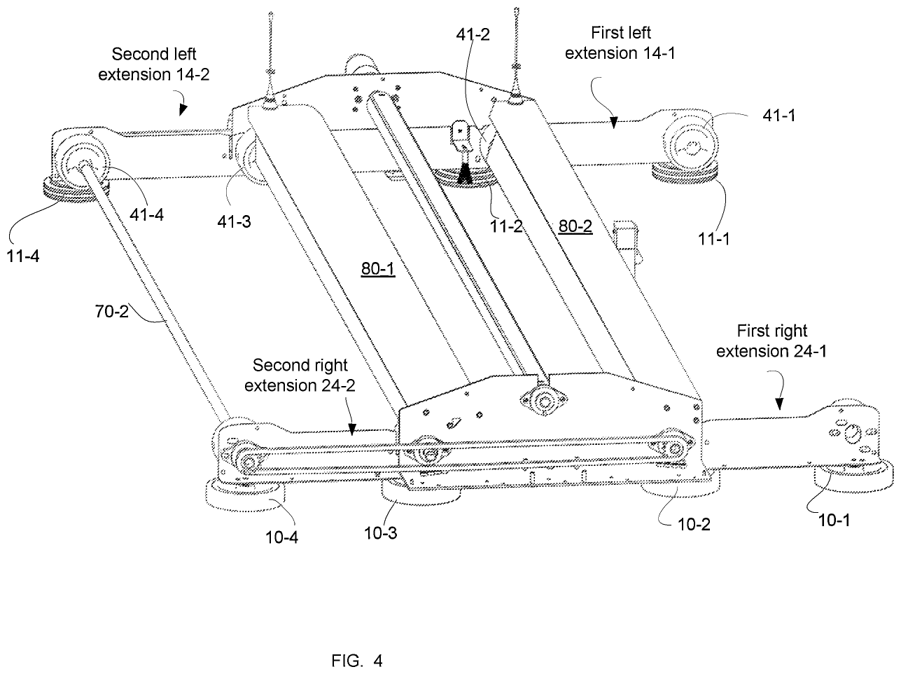

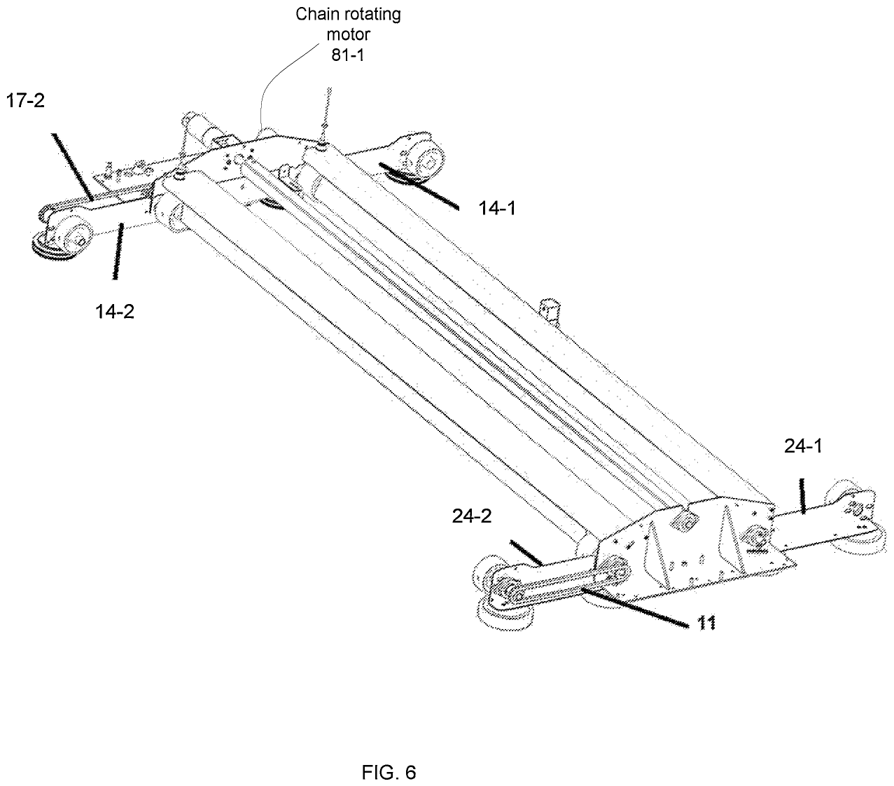

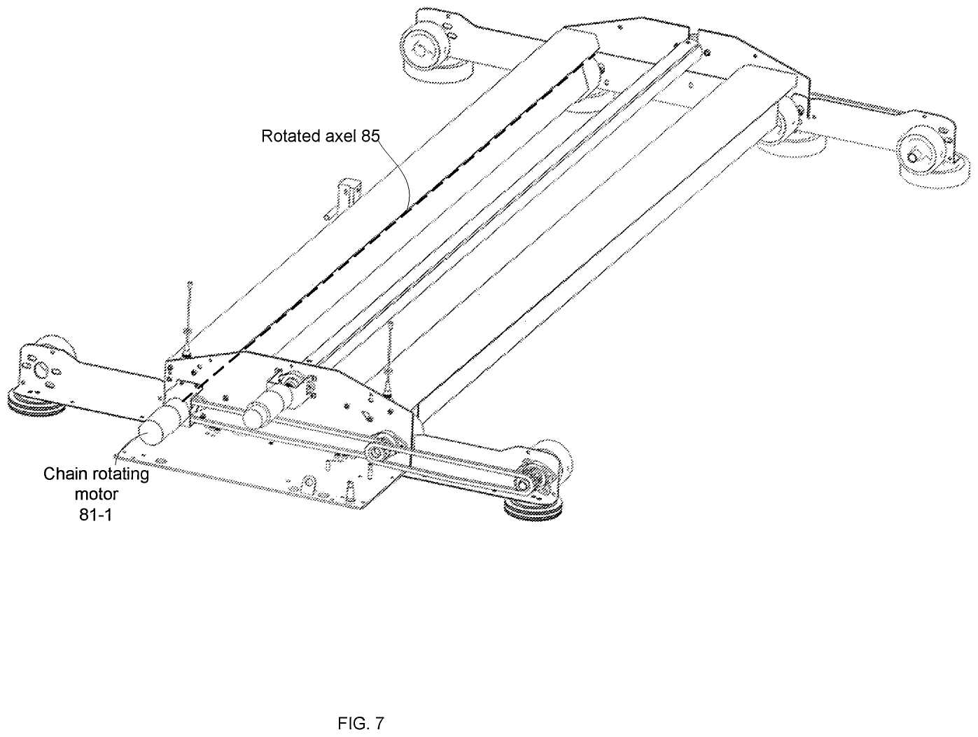

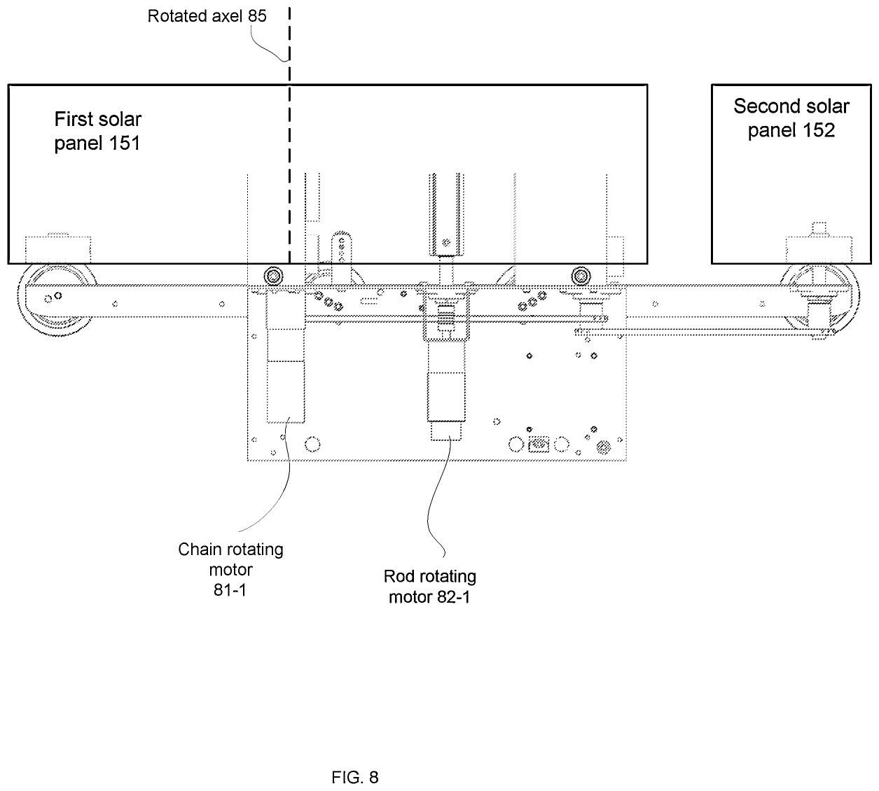

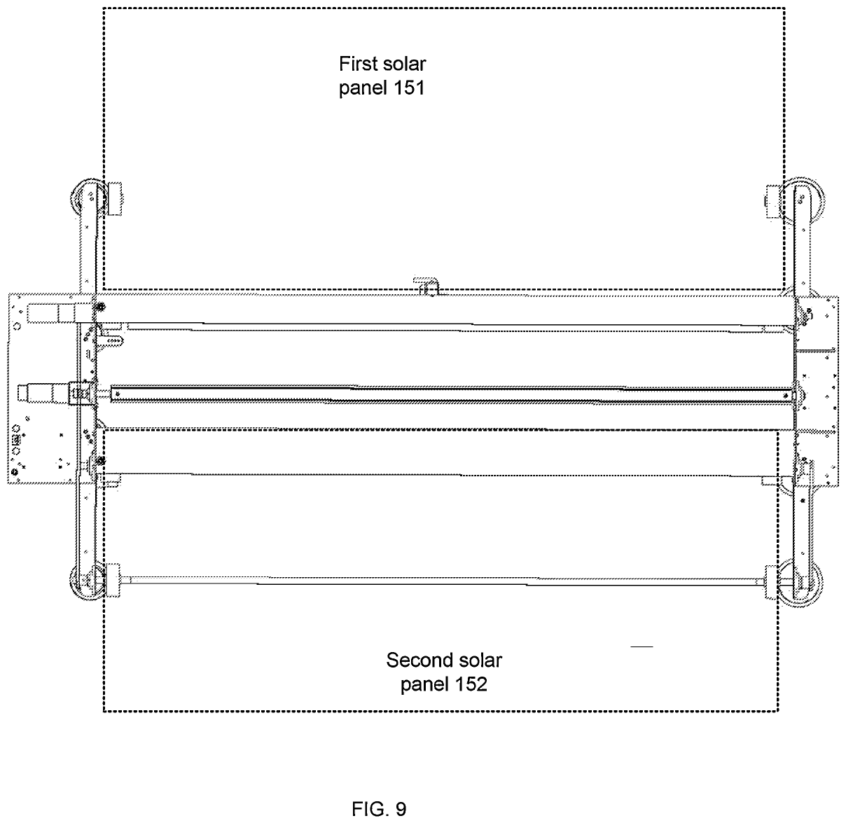

FIGS. 1-10 illustrate different example of surface cleaning devices, some of which differ from each other by the number and/or identities of rotatable wheels and/or by the mechanical transmission elements.

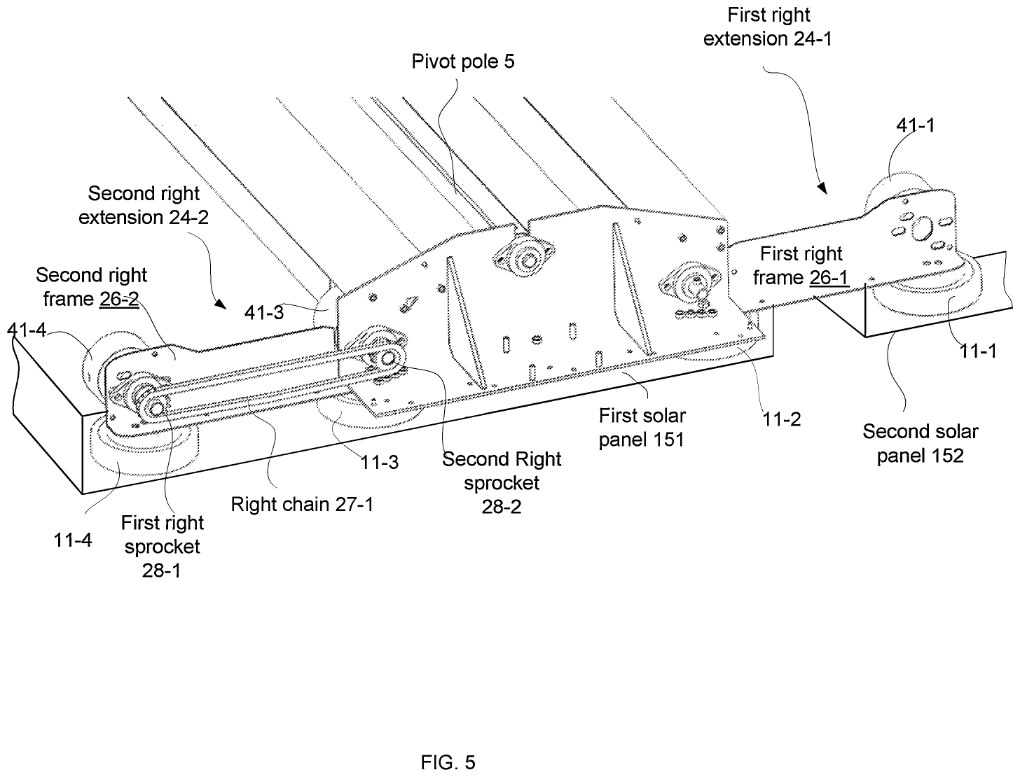

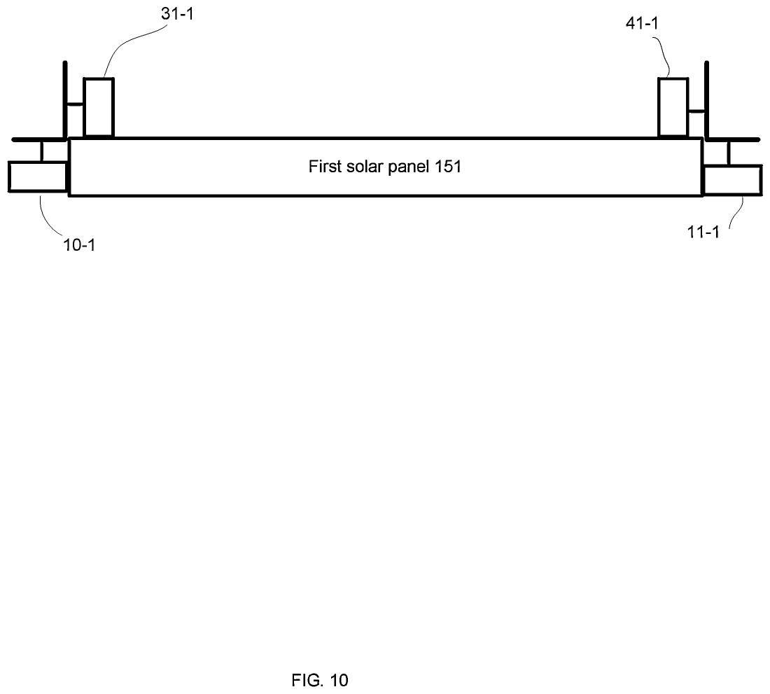

Various figures (for example FIGS. 5, 8 and 9) illustrate the surface cleaning device as contacting a first solar panel 151 and a second solar panel 152. FIG. 10 is a side view that illustrates the surface cleaning device as interfacing with the first solar panel 151.

In all examples there are four extensions that are arranged in a symmetrical manner about the main body.

The extensions include first left extension 14-1, second left extension 14-2, first right extension 24-1, second right extension 24-2. These extensions include frames such as first left frame 16-1, second left frame 16-2, first right frame 26-1, second right frame 26-2.

The wheels of the surface cleaning device include eight surface wheels 31-1, 31-2, 31-3, 31-4, 41-1, 41-2, 41-3, 41-4, and eight side wheels—10-1, 10-2, 10-3, 10-4, 11-1, 11-2, 11-3 and 11-4. Other number of surface wheels and/or any other number of side wheels may be provided.

Any number of wheels may be actively rotated—while zero, one or other wheels can freely rotate due to a progress of the surface cleaning device.

The figures illustrate chain rotating motor 81-1 although multiple chain rotating motors may be provided.

The figures illustrate one or more mechanical transmission elements such as chains 17-1, 17-2 and 27-1, sprockets such as sprockets 28-1, 18-1 and 18-3, and an rotated axel 85 that couples wheel that are opposite to each other.

By using more mechanical transmission elements—less chain rotating motors are required.

By rotating one or more wheels which are extension wheels—the surface cleaning device may easily overcome gaps between solar panels (especially vertical gaps) and/or elevated parts of a solar panel (small hills)—that can not be easily overcome by using only wheels of the main body.

The overall width of the surface cleaning device (including the extensions) may exceed a width of a single solar panel—(for example the overall width may be at least 1.1 meters). This may result in spreading the surface cleaning device weight on two solar panels—instead on a single solar panel. This dramatically decreases the load on each solar panel—and increases the lifespan of the solar panels. This may be achieved with a relatively minor extension of the surface cleaning device—for example an increase of 20 till 30 percent of the original weight.

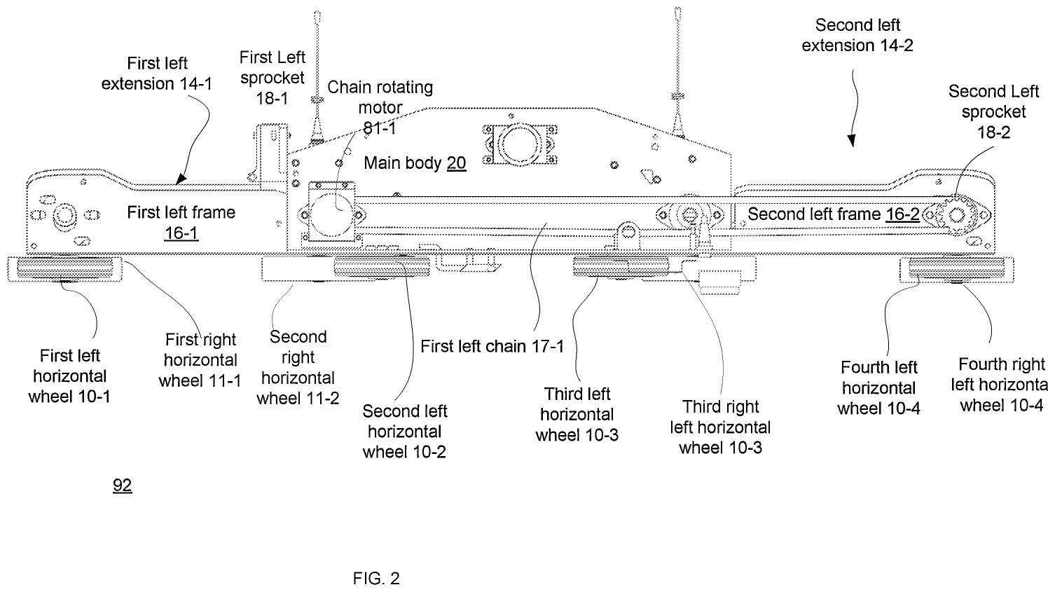

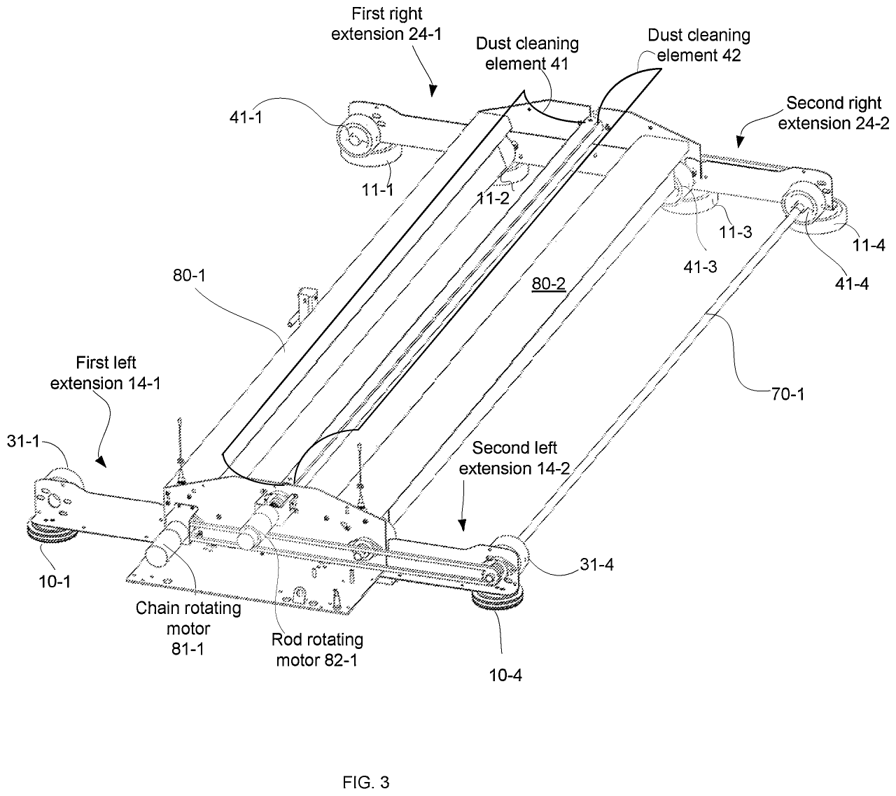

The surface cleaning device of FIGS. 2 and 3 includes a chain rotating motor 81-1 that may rotate surface wheels 31-2, 41-2, 31-4 and 41-4. The corresponding side wheels 10-2, 11-2, 10-4, and 11-4 may also be rotated assuming that there are mechanical transmission elements (not shown) that convey the rotation to them. The rotation of extension wheels 10-4, 11-4, 31-4 and 41-4 greatly improves the movability of the surface cleaning device.

The surface cleaning device of FIG. 1 includes a chain rotating motor 81-1 that may rotate surface wheels 31-2, 41-2, 31-3, 41-3, 31-4 and 41-4. The corresponding side wheels 10-2, 11-2, 10-3, 11-3, 10-4, and 11-4 may also be rotated assuming that there are mechanical transmission elements (not shown) that convey the rotation to them. The rotation of many wheels further improves the movability of the surface cleaning device.

It should be noted that all surface wheels and/or all side wheels may be rotated.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

Any reference to the term “comprising” or “having” should be applied mutatis mutandis to “consisting” and/or should be applied mutatis mutandis to “essentially consisting of”. For example—a method that comprises certain steps can include additional steps. A method that consists certain steps can be limited to the certain steps. A method that essentially consists of certain steps may include the certain steps as well as additional steps that do not materially affect the basic and novel characteristics of the method.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A surface cleaning device for cleaning surfaces of solar panels, wherein the surface cleaning device comprises:
a main body;
at least one extension that extends to at least one side of the main body and comprise at least one extension wheel for interfacing with the solar panels;
a first dust carrying member;
a second dust carrying member;
a motor; and
one or more motion delay assemblies; wherein the first dust carrying member and the second dust carrying member are coupled to the motor; wherein the motor is configured to cyclically move the first dust carrying member and the second dust carrying member along a path; wherein the one or more motion delay assemblies are configured to cyclically introduce a momentarily delay in a progress of the first dust carrying member along the path, while the second dust carrying member contacts the surface thereby reducing a gap between the first dust carrying member and the second dust carrying member and induce air to exit the gap and progress along the surface and remove dust that precedes the second dust carrying member.

2. The surface cleaning device according to claim 1 wherein the at least one extension is multiple extensions that extends to both sides of the main body and comprise one or more extension wheels for interfacing with the solar panels.

3. The surface cleaning device according to claim 2 wherein the extension wheels comprise surface wheels that are configured to interface with the surfaces of the solar panels and side wheels that are configured to interface with sidewalls of the solar panels.

4. The surface cleaning device according to claim 2 wherein a width of the surface cleaning device exceeds a width of a single solar panel.

5. The surface cleaning device according to claim 2 wherein the multiple extensions are arranged in a symmetrical manner about the main body.

6. The surface cleaning device according to claim 2 wherein a center of gravity of the surface cleaning device is located at the main body.

7. The surface cleaning device according to claim 2 comprising one or more rotating elements for rotating at least some of the extension wheels.

8. The surface cleaning device according to claim 7 wherein the rotating elements comprises at least one rotating motor and one or more mechanical transmission elements for transmitting rotational motion from the one or more rotating motor to at least some of the extension wheels.

9. The surface cleaning device according to claim 8 wherein the one or more mechanical transmission elements comprises chains and sprockets.

10. The surface cleaning device according to claim 8 wherein the one or more mechanical transmission elements comprises chains, sprockets and an axel that couples extension wheel that are opposite to each other.

11. The surface cleaning device according to claim 2 wherein a distance between a pair of adjacent surface wheels exceeds a first predefined distance, wherein at least one of the pair is an extension wheel.

12. The surface cleaning device according to claim 11 wherein the first predefined distance exceeds 20 centimeters.

13. The surface cleaning device according to claim 2 wherein a distance between a pair of adjacent side wheels exceeds a second predefined distance, wherein at least one of the pair is an extension wheel.

14. The surface cleaning device according to claim 11 wherein the second predefined distance exceeds 20 centimeters.

15. The surface cleaning device according to claim 1 comprising a movement mechanism that is configured to move the surface cleaning device in relation to the solar panels.

16. The surface cleaning device according to claim 15 wherein the movement mechanism comprises one or more rotating elements for rotating at least some wheels of a group of wheels of the surface cleaning device.

17. The surface cleaning device according to claim 16 wherein the at least some wheels comprise an extension wheel.

18. The surface cleaning device according to claim 16 wherein the at least some wheels comprise a wheel that is not an extension wheel.

19. A method of cleaning a surface by a surface cleaning device, comprising:
cyclically moving, by a motor of the surface cleaning device, a first dust carrying member and a second dust carrying along a path;
cyclically introducing, by one or more motion delay assemblies of the surface cleaning device, a momentarily delay in a progress of the first dust carrying member along the path, while the second dust carrying member contacts the surface thereby reducing a gap between the first dust carrying member and the second dust carrying member and inducing air to exit the gap and progress along the surface and remove dust that precedes the second dust carrying member;
moving, by a movement mechanism, the surface cleaning device in relation to the solar panels, wherein the movement comprises moving at least one extension wheel of at least one extension of the surface cleaning device, the at least one extension extends to at least one side of a main body of the surface cleaning device.

20. The method according to claim 19 wherein the moving comprises moving over a gap between one solar panel to another solar panel without using a bridge.
